(19) United States
(12) Patent Application Publication
(10) Pub. No.: US 2026/0065760 A1
(43) Pub. Date: Mar. 5, 2026

(54) INFORMATION OUTPUT DEVICE, INFORMATION OUTPUT METHOD, AND INFORMATION OUTPUT PROGRAM

(71) Applicant: Panasonic Intellectual Property Management Co., Ltd., Osaka (JP)

(72) Inventor: SATORU SUZUKI, Osaka (JP)

(21) Appl. No.: 19/383,825

(22) Filed: Nov. 10, 2025

Related U.S. Application Data
(63) Continuation of application No. PCT/JP2024/014476, filed on Apr. 10, 2024.

(30) Foreign Application Priority Data
May 22, 2023 (JP) 2023-083871

(51) Int. Cl. G08B 7/06; G06F 40/20; G06F 40/40

(52) U.S. Cl. CPC G08B 7/06; G06F 40/20; G06F 40/40

(57) ABSTRACT

An information output device includes: an information detector that detects reception of information; an information processing unit that generates notification data accompanied by emotional expression according to a degree of influence of the information on a user; and a notification output unit that outputs the notification data.

### TECHNICAL FIELD

The present disclosure relates to an information output device, an information output method, and an information output program.

### BACKGROUND ART

There is known a technique of identifying information to be notified to a user and executing a notification at a better notification timing. PTL 1 discloses a technique of determining a timing of notification to a user based on an importance degree calculated from notification information and an acceptance degree calculated from behavior information of the user.

### CITATION LIST

### Patent Literature

PTL 1: Unexamined Japanese Patent Publication No. 2014-123192

### SUMMARY OF THE INVENTION

However, the technique described in PTL 1 only executes notification at a timing better for the user, so in a case where the user feels troublesome respond to the notification, the user does not necessarily take an action according to the information to be notified. That is, it is not possible to provide an opportunity for the user to take an action according to the notification information only by making a notification at a better timing.

The present disclosure solves the above problem, and an object of the present disclosure is to provide an information output device, an information output method, and an information output program that enable prompting a user to take an action according to notification information.

In order to solve the above problem, an aspect of an information output device according to the present disclosure includes: an information detector that detects reception of information; an information processing unit that generates notification data accompanied by emotional expression according to a degree of influence of the information on a user; and a notification output unit that outputs the notification data.

In addition, an aspect of an information output method according to the present disclosure includes: detecting reception of information; generating notification data accompanied by emotional expression according to a degree of influence of the information on a user; and outputting the notification data.

Furthermore, an aspect of an information output program according to the present disclosure causes a computer to execute: detecting reception of information; generating notification data accompanied by emotional expression according to a degree of influence of the information on a user; and outputting the notification data.

According to the present disclosure, it is possible to prompt a user to take an action according to notification information.

### BRIEF DESCRIPTION OF THE DRAWINGS

FIG. 1 is a block diagram illustrating a functional configuration of an information output device according to the present exemplary embodiment.

FIG. 2 is a diagram illustrating an example of notifying a user of advice accompanied by emotion when a mobile terminal possessed by the user receives an email.

FIG. 3 is a flowchart indicating an operation of the information output device.

FIG. 4 is a diagram illustrating an example of a notification sentence and data of emotional expression.

FIG. 5 is a diagram illustrating correction of a degree of influence performed according to elapse of time.

### DESCRIPTION OF EMBODIMENT

Hereinafter, an exemplary embodiment of the present disclosure will be described with reference to the drawings. Note that, each exemplary embodiment to be described below indicates one specific example of the present disclosure. Therefore, constituent elements, arrangement positions and connection forms of the constituent elements, steps and order of steps, and the like to be indicated in the following exemplary embodiment are examples, and they are not intended to limit the present disclosure. In addition, among the constituent elements in the following exemplary embodiment, constituent elements not recited in the independent claims are described as optional constituent elements.

Furthermore, each drawing is schematically illustrated and thus is not strictly accurate. Note that, in each drawing, substantially the same configurations are denoted by the same reference marks to eliminate or simplify duplicated description.

### Exemplary Embodiment

### [Outline of Information Output Device]

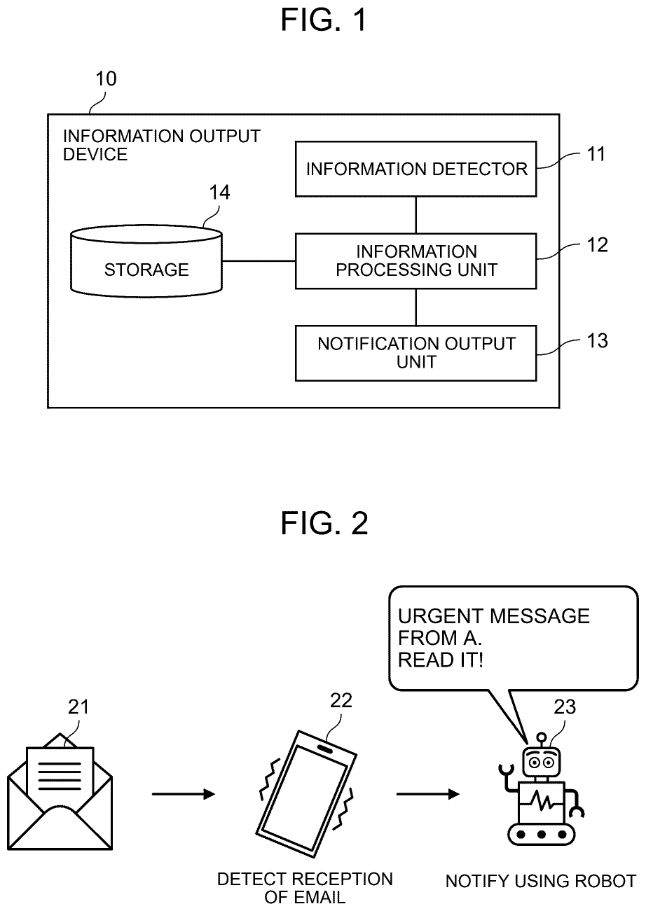

First, a configuration of an information output device according to the present exemplary embodiment will be described. Here, a case where the information output device according to the present disclosure is introduced into a general-purpose mobile terminal will be described as an example. FIG. 1 is a block diagram illustrating a functional configuration of information output device 10 according to the present exemplary embodiment.

Information output device 10 includes information detector 11, information processing unit 12, notification output unit 13, and storage 14. Information output device 10 is a device that, in a case where reception of information is detected by information detector 11, outputs a notification accompanied by emotional expression according to content of the received information. For example, this notification is advice for prompting a user to take an action, and by outputting such a notification accompanied by emotional expression, it is possible to prompt the user to take an action according to the notification.

### [Configuration of Information Output Device 10]

Hereinafter, the configuration of information output device 10 will be described in detail. Information detector 11 detects information delivered to a mobile terminal possessed by the user. The information to be detected is, for example, a message including a text such as an email, a chat, or a short message.

The length of the message is not limited, and for example, an image, a moving image, or a voice may be included in the message and a type thereof is not particularly limited. Specifically, information detector 11 is implemented by a microcomputer, but may be implemented by a processor.

Information processing unit 12 generates notification data accompanied by emotional expression using information delivered to the mobile terminal possessed by the user as an input. The notification data accompanied by emotional expression includes, for example, a notification sentence and data of emotional expression corresponding to the notification sentence. Specifically, information processing unit 12 is implemented by a microcomputer, but may be implemented by a processor.

Notification output unit 13 outputs the notification sentence and the data of emotional expression generated by information processing unit 12. FIG. 2 is a diagram illustrating an example in which robot 23 notifies the user of advice accompanied by emotional expression when mobile terminal 22 possessed by the user receives email 21. Mobile terminal 22 is a smartphone, a tablet, a notebook PC, or the like. Note that mobile terminal 22 is not limited to a portable information terminal, and may be an information terminal such as a desktop PC.

In the example illustrated in FIG. 2, notification output unit 13 outputs the notification sentence and the data of emotional expression to robot 23 including a speaker capable of voice output and a body mechanism capable of body expression. For example, the emotional expression is expressed by the facial expression of robot 23, such as a confused expression, an angry expression, or a sad expression.

Mobile terminal 22 outputs the notification sentence and the data of emotional expression to robot 23 using communication such as Bluetooth (registered trademark). Note that communication with robot 23 or the like by mobile terminal 22 is not limited to wireless communication, and may be performed by wired communication.

For example, based on the data of emotional expression received from information output device 10, robot 23 expresses the emotion by the expression of the face, moves the hand up and down, rotates the hand, or rotates the leg belt to move left and right. In addition, in a case of a dog-shaped robot, the user may be notified by the emotional expression of the dog or an attitude such as stepping on the ground.

Moreover, based on the notification sentence received from information output device 10, robot 23 reads out the advice “Urgent message from A. Read it!”.

Note that information output device 10 may display the notification sentence on a display panel, a tablet, or the like installed on the chest of robot 23.

Note that mobile terminal 22 may output the notification sentence and the data of emotional expression to a display controller or a voice output controller of mobile terminal 22 without notifying robot 23 or the like. In this case, mobile terminal 22 may display the notification sentence and the emotional expression of the face on a display of mobile terminal 22, or may read out the notification sentence from a speaker accompanied by the emotional expression such as a confused voice or an angry voice.

In addition, mobile terminal 22 may display an avatar such as an animal on the display and cause the avatar to express the emotions. In this case, mobile terminal 22 may cause the display to display the notification sentence or may cause the avatar to read out the notification sentence.

Storage 14 is a storage device that stores a program for information processing unit 12 to execute information processing, various types of information necessary for the information processing, and the like. Storage 14 is implemented by, for example, a semiconductor memory or the like.

### [Operation]

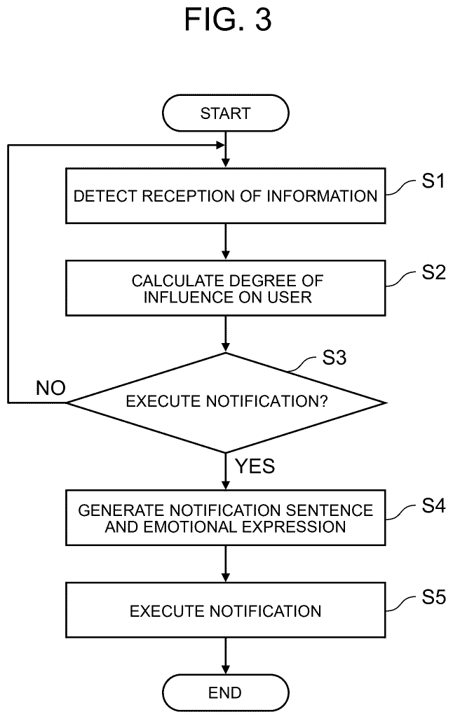

Next, an operation of information output device 10 will be described. FIG. 3 is a flowchart indicating the operation of information output device 10. Note that the order of the pieces of processing indicated in the flowchart of FIG. 3 is an example. The order of the pieces of processing may be changed, or a plurality of pieces of processing may be executed in parallel. For example, calculation of the degree of influence on the user (step S2) and generation of the notification sentence and the emotional expression (step S4) may be performed in parallel.

First, information detector 11 detects reception of information by mobile terminal 22 of the user (step S1). Hereinafter, the received information is referred to as reception information. The reception detection of information may be, for example, detection of information reception itself or detection of information generated when an application installed in mobile terminal 22 receives information.

Next, information processing unit 12 calculates the degree of influence of the reception information on the user (step S2). Examples of the degree of influence of the reception information on the user include a degree of urgency of the information, a degree of importance of the information, and the like.

Information detector 11 can use the information indicating urgency or importance input by a sender of the reception information for calculation of the degree of influence of the reception information on the user. For example, in a case where the sender of the reception information sets an urgent or important flag in an email, information detector 11 uses the information to calculate the degree of influence on the user.

In a case where such information indicating urgency or importance is not given by the sender, information processing unit 12 determines at least one of urgency and importance from the content of the reception information, thereby calculating the degree of influence.

For example, in a case where the reception information includes text and voice, at least one of urgency and importance is determined by applying text analysis to the content, and the degree of influence is calculated from the result.

In addition, information processing unit 12 may obtain the degree of influence of the reception information on the user by comparing the reception information with existing information. For example, information processing unit 12 may calculate the degree of influence of the reception information on the user by extracting features of sentence data having urgency and importance collected in advance and comparing the features with features of the reception information.

For example, the comparison between the reception information and the existing information may be performed by calculating similarity between a feature vector including a plurality of feature amounts of the reception information and a feature vector including the plurality of feature amounts of the existing information.

Then, information processing unit 12 determines whether to notify the user of the reception information (step S3). For example, information processing unit 12 determines the execution determination of notification based on whether the degree of influence exceeds a threshold value. As the threshold value, a fixed value set by the device may be used, or a user may set an arbitrary value.

In a case where it is determined to notify the user of the reception information (step S3, YES), information processing unit 12 generates the notification sentence and the data of emotional expression to be notified to the user according to the degree of influence (step S4).

Then, notification output unit 13 outputs the notification sentence and the data of emotional expression to robot 23, and notifies the user via robot 23 (step S5).

For example, as illustrated in FIG. 2, robot 23 that has acquired the notification sentence and the data of emotional expression notifies the user of the content of the notification sentence accompanied by the emotional expression. The emotional expression may be expressed by, for example, an expression or a body motion of robot 23, may be expressed by voice, or may be combined.

In a case where it is determined not to notify the user of the reception information (step S3, NO), the processing returns to step S1, and the subsequent processing is continued.

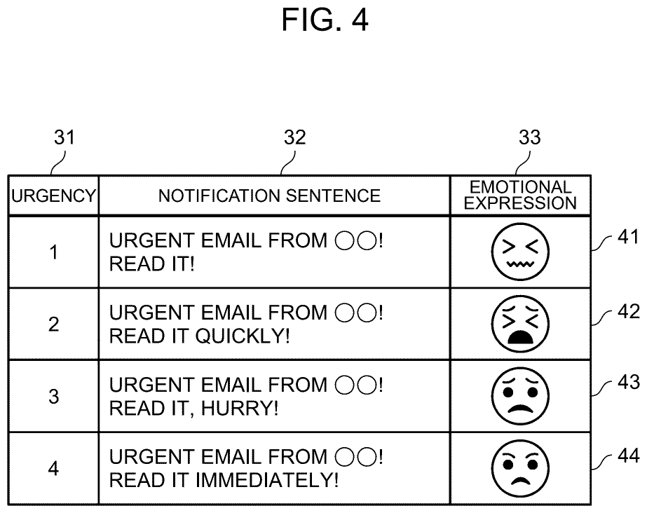

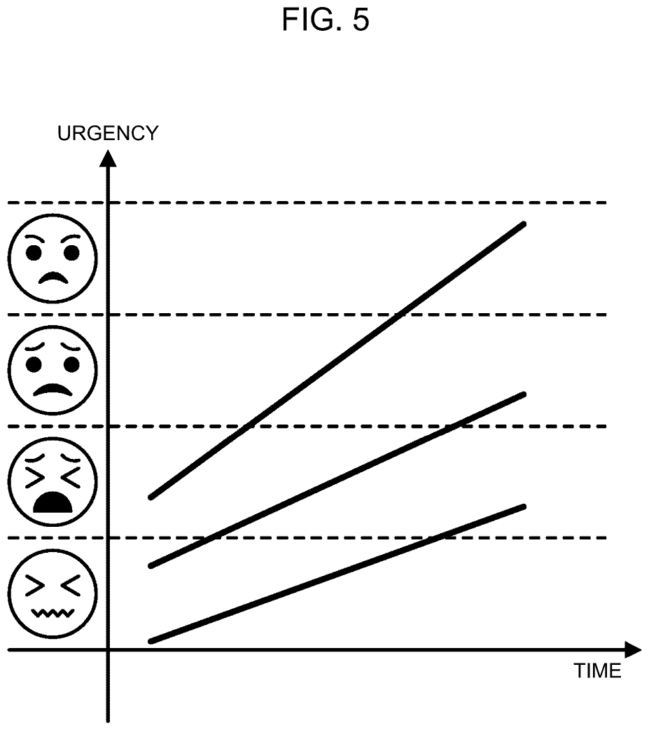

Next, a method of generating the notification sentence and the data of emotional expression will be described using urgency 31 of the reception information as an example. FIG. 4 is a diagram illustrating an example of notification sentence 32 and data of emotional expression 33. Notification sentence 32 and emotional expression 33 are expressed, for example, in four stages, and it is determined which notification sentence 32 and emotional expression 33 are to be used by comparison with the threshold value of urgency 31.

For example, in a case where the degree of influence calculated in step S2 of FIG. 3 is 1 or more and less than 2 which is the threshold value of urgency 31, information processing unit 12 generates notification sentence 32 of “Urgent email from ○○! Read it!” and causes robot 23 to read notification sentence 32. In addition, information processing unit 12 generates the data of emotional expression 33 that causes robot 23 to make confused expression 41, and causes robot 23 to make confused expression 41.

In a case where the degree of influence is 2 or more and less than 3, information processing unit 12 generates notification sentence 32 of “Read it quickly!” and causes robot 23 to read out notification sentence 32. In addition, information processing unit 12 generates the data of emotional expression 33 that causes robot 23 to make more confused expression 42, and causes robot 23 to make more confused expression 42.

In a case where the degree of influence is 3 or more and less than 4, information processing unit 12 generates notification sentence 32 of “Read it, hurry!” and causes robot 23 to read out notification sentence 32. In addition, information processing unit 12 generates the data of emotional expression 33 that causes robot 23 to make slightly angry expression 43, and causes robot 23 to make slightly angry expression 43.

In a case where urgency 31 is 4 or more, information processing unit 12 generates notification sentence 32 of “Read it immediately!” and causes robot 23 to read out notification sentence 23. In addition, information processing unit 12 generates the data of emotional expression 33 that causes robot 23 to make angry expression 44, and causes robot 23 to make angry expression 44.

Note that the threshold value of urgency 31 may be expressed, for example, in 10 stages, or designation of the number of stages may be received from the user. In addition, emotional expression 33 illustrated in FIG. 4 are examples, and are not limited to the confused expression and the angry expression and may be a sad expression or the like.

FIG. 5 is a diagram for describing correction of the degree of influence performed according to elapse of time. For example, in a case where the user has not reacted to the notification corresponding to the reception information, the degree of influence may be increased with elapse of time, and notification sentence 32 and the data of emotional expression 33 to be output to robot 23 may be corrected according to the newly obtained degree of influence. The timing to increase the degree of influence may be, for example, 30 minutes or 1 hour after the notification is made to the user, or after a time set by the user has elapsed.

Note that, in the exemplary embodiment described above, as illustrated in FIG. 4, the data of emotional expression is generated according to the degree of influence of the reception information on the user, but may be generated according to the expression of the sender of the reception information.

In this case, for example, information processing unit 12 photographs the face of the sender with the camera, and receives the photograph data transmitted by a dedicated application. Then, information processing unit 12 may generate the data of emotional expression corresponding to the expression of the sender, and information output unit 13 may output the data to robot 23 to cause robot 23 to make the expression.

In addition, in the exemplary embodiment described above, the case where information output device 10 is introduced into mobile terminal 22 has been described, but information output device 10 may be introduced into robot 23. In this case, in a case where mobile terminal 22 receives an email or the like, information detector 11 of information output device 10 acquires the information from mobile terminal 22 and executes the above-described processing.

Furthermore, robot 23 may be equipped with a function of receiving an email or the like, and information output device 10 may execute the above-described processing.

Although the exemplary embodiment has been described above, even if the timing of the notification is adjusted so that the user can easily recognize, the influence of causing the user to take an action does not change. Therefore, in a case where the user feels troublesome to respond to the notification, it is difficult to cause the user to take an action according to the information to be notified.

In order to improve this, information output device 10 includes information detector 11 that detects reception of information, information processing unit 12 that generates notification data accompanied by emotional expression according to the degree of influence of the information on the user, and notification output unit 13 that outputs the notification data.

As a result, as compared with a case where the notification is executed at a timing better for the user by adjusting the notification timing, information output device 10 can present emotional expression to the user according to the degree of influence of the information on the user. Therefore, information output device 10 can effectively prompt the user to take an action according to the notification information.

In addition, information detector 11 detects text information delivered to mobile terminal 22. As a result, information output device 10 can effectively prompt the user to take an action according to the notification information based on the text information.

In addition, information detector 11 receives at least one of information indicating urgency and information indicating importance input by the sender of the information as the degree of influence of the information on the user. As a result, information output device 10 can generate the notification data accompanied by the emotional expression using at least one of the urgency and the importance input by the sender of the information.

In addition, information processing unit 12 can calculate the degree of influence from the information delivered to mobile terminal 22. As a result, information output device 10 can effectively generate the notification data accompanied by the emotional expression.

In addition, information processing unit 12 compares the received information with the existing information stored in storage 14 to obtain the degree of influence of the information on the user. As a result, information output device 10 can efficiently obtain the degree of influence.

In addition, information processing unit 12 generates the notification sentence and the data indicating emotional expression as the notification data. As a result, information output device 10 can more effectively prompt the user to take an action.

In addition, notification output unit 13 outputs the notification data accompanied by emotional expression when the degree of influence exceeds the threshold value. As a result, since information output device 10 can output the notification data when the degree of influence is large, it is possible to effectively prompt the user to take an action when necessary.

In addition, information processing unit 12 increases the degree of influence with elapse of time after outputting the notification data accompanied by emotional expression, and notification output unit 13 newly outputs the notification data corresponding to the increased degree of influence. As a result, information output device 10 can prompt the user to take an action while preventing the user from being accustomed to the notification.

In addition, information processing unit 12 generates the notification data accompanied by emotional expression according to the expression of the sender of the information. As a result, it is possible to transmit the expression of the sender to the user, and to effectively prompt the user to take an action.

Although the exemplary embodiment is described above, the present disclosure is not limited to the exemplary embodiment described above.

For example, in the exemplary embodiment described above, each constituent element may be implemented by executing a software program suitable for each constituent element. Each constituent element may be implemented by a program executor such as a CPU or a processor reading and executing a software program recorded in a recording medium such as a hard disk or a semiconductor memory.

In addition, general or specific aspects of the present invention may be implemented by a device, a method, an integrated circuit, a computer program, or a computer-readable recording medium such as a CD-ROM. In addition, the present invention may be implemented by an arbitrary combination of a device, a method, an integrated circuit, a computer program, and a recording medium.

The present disclosure also encompasses exemplary embodiments obtained by making various modifications conceived by those skilled in the art to the exemplary embodiment and exemplary embodiments implemented by any combination of constituent elements and functions of the exemplary embodiment without departing from the scope of the present disclosure.

### INDUSTRIAL APPLICABILITY

The present disclosure can be used in an information output device, an information output method, and an information output program.

### REFERENCE MARKS IN THE DRAWINGS

10 information output device
11 information detector
12 information processing unit
13 notification output unit
14 storage
21 email
22 mobile terminal
23 robot
31 urgency
32 notification sentence
33 emotional expression
41 confused expression
44 angry expression

1. An information output device comprising:
an information detector that detects reception of information;
an information processing unit that generates notification data accompanied by emotional expression according to a degree of influence of the information on a user; and
a notification output unit that outputs the notification data.

2. The information output device according to claim 1, wherein the information detector receives text information as the information.

3. The information output device according to claim 1, wherein the information detector receives, as the degree of influence, at least one of information indicating urgency and information indicating importance input by a sender of the information.

4. The information output device according to claim 1, wherein the information processing unit calculates the degree of influence from the information.

5. The information output device according to claim 1, wherein the information processing unit obtains the degree of influence by comparing the information with existing information.

6. The information output device according to claim 1, wherein the information processing unit generates, as the notification data, a notification sentence and data indicating the emotional expression.

7. The information output device according to claim 1, wherein the notification output unit outputs the notification data when the degree of influence exceeds a threshold value.

8. The information output device according to claim 7, wherein the information processing unit increases the degree of influence with elapse of time after outputting the notification data, and the notification output unit newly outputs the notification data corresponding to the increased degree of influence.

9. The information output device according to claim 1, wherein the information processing unit generates the notification data according to an expression of a sender of the information.

10. An information output method comprising:
detecting reception of information;
generating notification data accompanied by emotional expression according to a degree of influence of the information on a user; and
outputting the notification data.

11. An information output program causing a computer to execute:
detecting reception of information;
generating notification data accompanied by emotional expression according to a degree of influence of the information on a user; and
outputting the notification data.
